(19) United States
(12) Patent Application Publication
(10) Pub. No.: US 2003/0230660 A1
(43) Pub. Date: Dec. 18, 2003

(54) Decoiling apparatus and methods for unwinding coiled material

(76) Inventor: Lance T. Vernam, Traverse City, MI (US)

Correspondence Address: KIRKPATRICK & LOCKHART LLP, 535 SMITHFIELD STREET, PITTSBURGH, PA, 15222, US

(21) Appl. No.: 10/172,104

(22) Filed: Jun. 14, 2002

(51) Int. Cl. A01K 89/015; B65H 49/00

(52) U.S. Cl. 242/271; 242/128

(57) ABSTRACT

Apparatus and methods for decoiling a member disposed within a coil. The coil may be supported within a shipping/storage container.

### BACKGROUND OF THE INVENTION

1. Field of the Invention

The subject invention relates generally to apparatuses and methods for unwinding coiled material and, more particularly, to apparatuses and methods for unwinding coiled welding wire.

2. Description of the Invention Background

Over the years, a variety of different automatic or semi-automatic machines have been developed for performing a various welding operations. Such machines typically automatically retrieve welding wire, which may be fabricated from, for example, steel or aluminum to use during welding processes. Such welding wire is usually wound into a coil which is stored and shipped in a container fabricated from cardboard or other material. U.S. Pat. No. 5,494,160 to Gelmetti, U.S. Pat. No. 5,758,834 to Dragoo et al. and European Patent Application No. 92110219.0 to the Lincoln Electric Company disclose welding wire storage containers. International Application No. WO 88/10230 to British Telecommunications Public Limited Company also discloses a container assembly for handling coiled fiber optic cable.

In a typical container arrangement, the wire is placed between the cylindrical core and the container and is retained in position during shipping by foam blocks that extend through the core and across the top of the coil of wire. To use the wire, the foam shipping blocks are removed and a payout member is attached to the top of the container. The payout member may include a rotating device or payoff arm that has an eyelet and a central conduit for guiding the wire to a wire feeding mechanism associated with the welding machine. In other arrangements, the payoff member has an orifice through which the wire is fed.

When using relatively soft wire, such as aluminum and the like, there is a danger that the wire can form a knot or fold over on itself as it is paid out of the top of the coil and prior to its entry into the orifice located in the lid. Such bending can damage the wire and plug the payout orifice in the lid. Thus, there is a need for apparatus and methods for preventing material being unwound from a coil from folding over or becoming knotted as it is unwound from the coil.

### SUMMARY OF THE INVENTION

In accordance with one embodiment of the present invention, there is provided a decoiling guide for a member disposed in a coil having an open cylindrical center area that has a diameter and a height. One embodiment of the decoiling guide comprises a body having a base end that has a base end diameter that is less than the central diameter of the central area of the coil and an unobstructed payoff end that is opposite to the base end. The body has a tapered discharge guide surface adjacent the payoff end and a length that is greater than or equal to the height of the coil.

Another embodiment of the present invention comprises a coil assembly that includes a member that is disposed in a coil that has an open central area and a height. The coil assembly further includes a decoiling guide sized to be removably received within the open central area of the coil and has a height that is substantially equal to or greater than the height of the coil. The decoiling guide has a tapered discharge surface portion for guiding a portion of the member as the coiled member is uncoiled from the coil.

Another embodiment of the present invention comprises a packaging arrangement for welding wire that includes a container that has a top portion, a bottom and a perimetrical shape. The packaging arrangement further includes a coil of welding wire that has a top, a perimetrical shape and an open central area. The coil is received within the container and is supported on the bottom thereof. The packaging arrangement further includes a discharge cone that is removably supported within the open area of the coil and extends from the container bottom to the top of the coil or therebeyond.

Another form of the present invention comprises a method of decoiling a member disposed in a coil that has a height and an open central area. One form of the method includes removably supporting a discharge member having a tapered guide surface within the open central area and decoiling the member from the coil such that a portion of decoiled member is supported by the tapered guide surface of the discharge member during decoiling.

### BRIEF DESCRIPTION OF THE DRAWINGS

FIG. 1 is a plan view of a coil housed in a container and employing one embodiment of a decoiling guide of the present invention;

FIG. 2 is a cross-sectional view of the container and schematic view of the coil taken along line II-II in FIG. 1;

FIG. 3 is an elevational view of one form of a decoiling guide of the present invention;

FIG. 4 is an exploded cross-sectional elevation view of another container and schematic view of the coil employing another decoiling guide of the present invention; and

FIG. 5 is a cross-sectional side elevational view of another decoiling guide of the present invention within a coil schematically depicted.

### DETAILED DESCRIPTION OF THE EMBODIMENTS OF THE INVENTION

Referring now to the drawings for the purposes of illustrating the present embodiments of the invention only and not for the purposes of limiting the same, it is to be understood that standard components or features that are within the purview of an artisan of ordinary skill are omitted from the drawings to enhance clarity of the various embodiments of the invention. One embodiment of the present invention is directed to a decoiling guide system 10 for uncoiling a member 12 disposed in a coil 14. While the various embodiments of the present invention are particularly well suited for use in connection with coiled welding wire such as, for example, aluminum welding wire for use in connection with automatic or semi-automatic welding machines, those of ordinary skill in the art will appreciate that the various embodiments of the present invention may be successfully employed to decoil a variety of different members disposed in a coil.

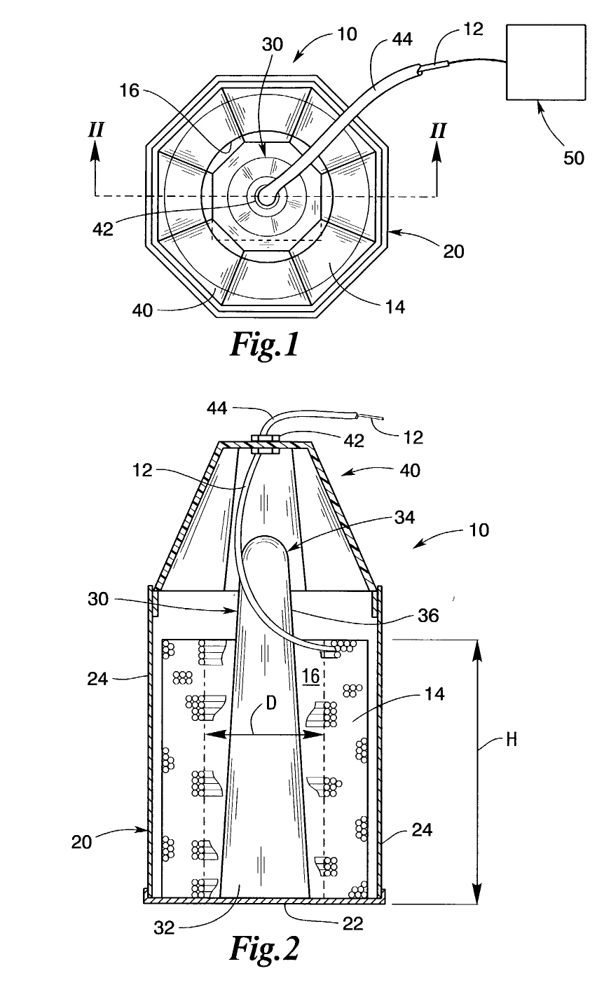

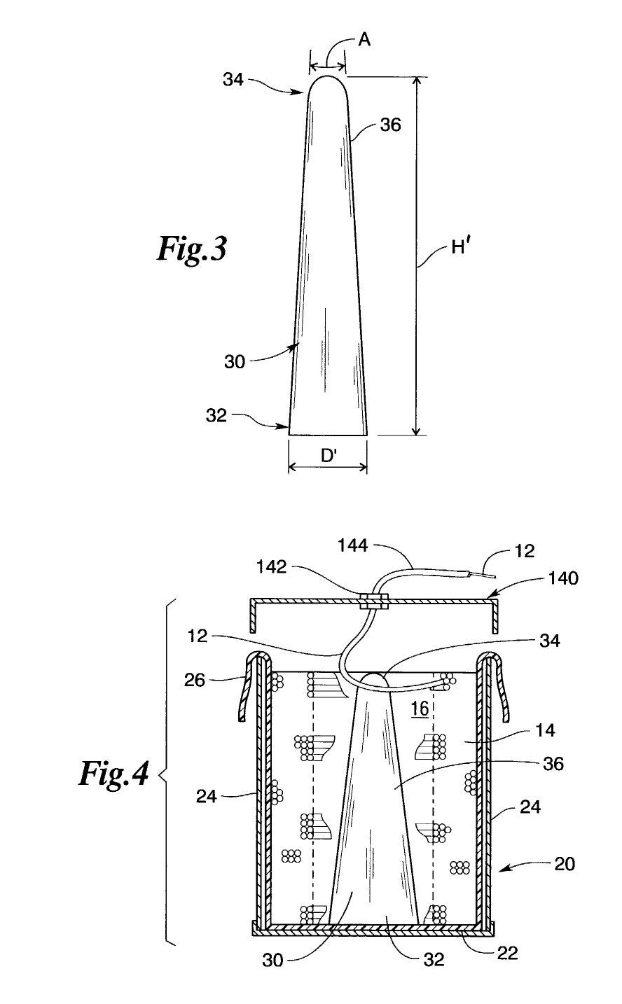

More particularly and with reference to FIGS. 1 and 2, there is shown a member 12 disposed in a coil 14 that is housed in a shipping container 20. In this embodiment, the shipping container 20 is fabricated from cardboard. However, the shipping container 20 may be fabricated from a variety of different materials in a variety of different shapes without departing from the spirit and scope of the present invention. The container 20 commonly has a bottom 22 and upstanding sidewalls 24 to protect the coil 14 during shipping. If desired, the coil 14 may be disposed in a flexible liner 26 made from, for example, a polymer material. See FIG. 3.

In the embodiments depicted in FIGS. 1-3, the coil 14 is substantially cylindrical in shape and has an open substantially cylindrical central area 16 that has a central diameter D. While the coil depicted in FIGS. 1 and 2 has a cylindrical open area, those of ordinary skill in the art will appreciate that the various decoiling devices of the present invention may be successfully employed in connection with coils having differently shaped open areas. Coil 14 further has a height H as shown in FIG. 2. As indicated above, coil 14 may comprise a member 12 in the form of, for example, aluminum welding wire that is disposed in the coil 14 in a known manner.

As can be seen in FIGS. 2 and 4, the present invention includes a removable decoiling guide 30. In one embodiment, the decoiling guide 30 has a base end 32 that has a base end diameter D′ that is less than the diameter D of the central area 16 of the coil 14 to enable the decoiling guide 30 to be oriented within the central area 16 of the coil 14 and be supported on the surface on which the coil 14 is supported which may be the bottom 22 of the container 20. In this embodiment, the decoiling guide 30 may have a height H′ that is greater than or equal to the maximum height H of coil 14. In this embodiment, the decoiling guide 30 may be conically shaped and may have a payoff end 34 that is opposite to the base end 32. In this embodiment, the payoff end 34 may be unobstructed. That is, the payoff end 34 may be relatively smooth and may lack any flanges or other protrusions, members, etc. that may affect the payoff travel of the member 12 as it is guided thereon during the uncoiling operation as will be discussed in further detail below.

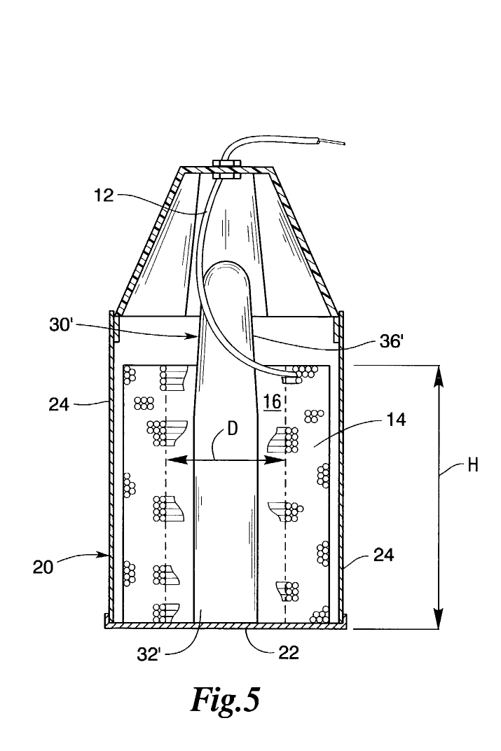

The decoiling guide 30 may be fabricated from a polymer material such as plastic or the like for ease of handling and manufacturing. However, the skilled artisan will readily appreciate that the decoiling guide 30 may be fabricated from a myriad of other suitable rigid materials that will not impeded payoff of the wire nor cause excessive or undue marking of the wire. In the embodiments depicted in FIGS. 1-4, the decoiling guide 30 is shaped as a substantially continuous cone with a tapered guide means or surface 36 that tapers from the base end 32 to the payoff end 34 at the predetermined included angle “A”. In one form of the present invention, the predetermined included angle “A” is selected from a range of predetermined included angles of ½° to 60°. Those of ordinary skill in the art will appreciate that a decoiling guide 30′ may also be fabricated with a non-tapered lower portion 32′ and a tapered upper portion 36′ such as the decoiling guide 30′ shown in FIG. 5. By way of example only, for a coil that has a maximum starting height of approximately 35 inches and a central area that has a diameter of approximately 13 inches, a decoiling guide that has a height of approximately 41 inches, and a base diameter D′ of approximately 10 inches and a tapered discharge guide surface end with an included angle A of approximately 5 degrees may be used.

In the embodiment depicted in FIGS. 1 and 2, a separate closure member or lid (not shown) may be employed during shipping. When the coil 14 is to be used, the closure member is removed from the container 20 and, if the coil 14 is in a flexible liner 26, the liner 26 is opened to enable a decoiling guide 30 to be removably inserted into the central area 16 of the coil 14. In the embodiment depicted in FIGS. 1 and 2, a payout member 40 is placed on top of the container 20 perimeter and the free end of the member 12 is inserted through an orifice fitting 42 mounted in the top of the payout member 40. Such payout members 40 are known in the art. The member 12 may then pass through a conduit 44 to a welding or other machine or welding wire feedout mechanism 50 located remote from the coil 14. The welding machine/welding wire payout mechanism 50 draws the member 12 from the coil 14 and the member 12 is slidably guided by the tapered guide surface 36 of the decoiling member 30.

Another form of payout member 140 is shown in FIG. 4. In that embodiment, the member 12 is passed through an orifice 142 in the payout member 140 and into a conduit 144 for transfer to a remote machine or apparatus. Those of ordinary skill in the art will appreciate that the tapered guide surface 36 serves to prevent the member 12 from folding over on its self or becoming tangled as it unwinds from the coil 14 and is fed through the payout member 40. If prior to the coil being completely used, the welding process is discontinued and the member 12 is detached from the welding machine 50, the user may simply remove the decoiling member 30 and replace the container closure on the container 20 to store the coil 14 until it is again needed. Those of ordinary skill in the art will appreciate that the portable nature of the decoiling member 30 enables it to be moved from coil to coil to be used wherever it is needed.

Although various embodiments of the present invention are particularly well suited for use in connection with a system for dispensing coiled aluminum welding wire, those of ordinary skill in the art will readily appreciate that the systems and methods of the present invention may be effectively employed with a myriad of other coiled member arrangements. Other bulk wire delivery systems typically have a cylinder within the core of the coil. The cylinder typically does not touch the wire. The use of the cylinder does not permit the wire to uncoil freely. Typically, when using a cylinder with parallel sides, the wire will constrict around the cylinder and added force is necessary to overcome the constriction. The added force will result in a higher rate of feeding and welding problems (for example burnbacks). By using a tapered core, the wire does not constrict to the same degree and the force necessary to overcome the constriction of the wire around the tapered core is reduced from that found when using a core with parallel sides.

Thus, from the foregoing discussion, it is apparent that various embodiments of the present invention provide the user with a readily portable and reusable device for facilitating the automatic or semiautomatic decoiling of aluminum welding wire or other material that is disposed in a coil. While the present invention has been shown and described in conjunction with examples and preferred embodiments thereof, variations in and modifications to the present invention may be effected by persons of ordinary skill in the art without departing from the spirit and scope of the present invention. It is therefore to be understood that the principles described herein may apply in a similar manner, where applicable, to all examples and preferred embodiments and the following claims are intended to cover all equivalent embodiments.

What is claimed is:

1. A decoiling guide for a member disposed in a coil having an open cylindrical center area that has a diameter and a height, said decoiling guide comprising a body having a base end that has a base end diameter that is less than the central diameter of the central area of the coil and an unobstructed payoff end opposite said base end and a tapered discharge guide surface adjacent said payoff end, said body having a length that is greater than or equal to the height of the central area of the coil.

2. The decoiling guide of claim 2 wherein said tapered discharge guide surface end has a predetermined included angle.

3. The decoiling guide of claim 2 wherein said predetermined included angle is selected from a range of predetermined included angles.

4. The decoiling guide of claim 3 wherein said range of predetermined included angles is ½° to 60°.

5. The decoiling guide of claim 1 wherein said body is fabricated from a rigid material.

6. The decoiling guide of claim 1 wherein a lower portion of said body is non-tapered.

7. A decoiling guide for a member disposed in a coil having an open cylindrical center area that has a diameter and a height, said decoiling guide comprising a body having a length that is greater than or equal to the height of the central area of the coil and a base end that has a base end diameter that is less than the central diameter of the central area of the coil, said body further having an unobstructed payoff end opposite said base end, said body further having tapered guide means adjacent said payoff end for guiding a portion of said member as it is uncoiled from the coil.

8. The decoiling guide of claim 7 wherein said guide means comprises a conical surface tapering at a predetermined included angle.

9. The decoiling guide of claim 8 wherein said predetermined included angle is selected from a range of predetermined included angles.

10. The decoiling guide of claim 9 wherein said range of predetermined included angles is ½° to 60°.

11. The decoiling guide of claim 7 wherein said body is fabricated from a rigid material.

12. The decoiling guide of claim 7 wherein a portion of said body having a non-tapered portion adjacent said base end.

13. A coil assembly, comprising:
a member disposed in a coil having an open central area and a height; and
a decoiling guide sized to be removably received within said open central area of said coil and having a height that is substantially equal to or greater than the height of said coil, said decoiling guide having a tapered discharge surface portion for guiding a portion of said member as said coiled member is uncoiled from said coil.

14. The coil assembly of claim 13 wherein said decoiling guide comprises a body having a base and a payoff end and wherein said tapered discharge surface tapers from said base to said payoff end.

15. The coil assembly of claim 14 wherein said predetermined included angle is selected from a range of predetermined included angles.

16. The coil assembly of claim 15 wherein said range of predetermined included angles is ½° to 60°.

17. The coil assembly of claim 14 wherein said body is fabricated from a rigid material.

18. The coil assembly of claim 13 wherein said decoiling guide has a non-tapered portion.

19. The coil assembly of claim 13 wherein said coil is supported within a container.

20. The coil assembly of claim 19 further comprising a payout member supported on said container for receiving said portion of said member after it departs from said tapered guide surface.

21. The coil assembly of claim 20 wherein said payout member comprises a conically shaped housing extending from a top portion of said container and having a payout conduit attached thereto.

22. The coil assembly of claim 13 wherein said member comprises welding wire.

23. The coil assembly of claim 22 wherein said welding wire is aluminum welding wire.

24. The coil assembly of claim 13 wherein said coil is substantially cylindrically shaped.

25. The coil assembly of claim 24 wherein said cylindrically shaped coil is received within an octagonally shaped container.

26. The coil assembly of claim 25 further comprising a flexible liner medium between said coil and said container.

27. A packaging arrangement for welding wire, comprising:
a container having a top portion, a bottom and a perimetrical shape;
a coil of welding wire having a top and perimetrical shape and an open central area, said coil received within said container and supported on the bottom thereof; and
a discharge cone removably supported within said open area of said coil and extending from said container bottom to said top of said coil or therebeyond.

28. The packaging arrangement of claim 27 wherein said perimetrical shape of said coil differs from said perimetrical shape of said container.

29. The packaging arrangement of claim 27 further comprising a flexible liner medium between said coil and said container.

30. The packaging arrangement of claim 27 further comprising a payout member supported on said top portion of said container.

31. A method of decoiling a member disposed in a coil having a height and an open central area comprising:
removably supporting a discharge member having a tapered guide surface within the open central area; and
decoiling the member from the coil such that a portion of decoiled member is guided by the tapered guide surface of the discharge member during said decoiling.

32. The method of claim 31 further comprising feeding the decoiled member to a location remote from the coil.

33. The method of claim 31 comprising removing the discharge member from the open area prior to decoiling all of the member from the coil.

34. The method of claim 31 further comprising placing the coil into a container prior to said decoiling.
